(19) United States
(12) Patent Application Publication
(10) Pub. No.: US 2005/0172056 A1
(43) Pub. Date: Aug. 4, 2005

(54) Bridging apparatus and method for enabling a UPnP device to control a PLC device

(75) Inventor: Jin-yong Ahn, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/042,381

(22) Filed: Jan. 26, 2005

(30) Foreign Application Priority Data
Feb. 2, 2004 (KR) 10-2004-0006670

(51) Int. Cl. G05B 19/18

(52) U.S. Cl. 710/72

(57) ABSTRACT

Provided are an apparatus and method for enabling Power Line Control (PLC) devices to work like Universal Plug And Play (UPnP) devices by allowing the PLC devices to participate in a UPnP network. A bridging apparatus for enabling the UPnP device to control the PLC device includes a unit for generating a device description XML document for each device type using information on the PLC devices and transmitting the same document to a UPnP control point; a unit for, upon receipt of a control command from the control point, converting the control command into a control command conforming to a PLC protocol and transmitting the converted control command to a PLC device, and for, upon receipt of an information packet conforming to the PLC protocol from the PLC device, converting the packet to an event message conforming to a UPnP protocol and transmitting the event message to the control point.

### CROSS-REFERENCE TO RELATED APPLICATION

This application claims the priority of Korean Patent Application No. 10-2004-0006670 filed on Feb. 2, 2004 in the Korean Intellectual Property Office, the disclosure of which is incorporated herein in its entirety by reference.

### BACKGROUND OF THE INVENTION

1. Field of the Invention

The present invention relates to a method for enabling compatibility between Universal Plug And Play (UPnP) and Power Line Control (PLC) networks, and more particularly, to an apparatus and method for enabling a PLC device to work like a UPnP device by allowing the PLC device to participate in an UPnP network.

2. Description of the Related Art

FIG. 1 shows the operation of a conventional PLC network. Referring to FIG. 1, PLC devices 10, 20, and 30 connect to a PLC gateway 50 via a power line, and the PLC gateway 50 connects to a PLC server through an Ethernet. A Home PAD 40 and other external devices for controlling the PLC devices 10, 20, and 30 connect to the PLC server 100 via IEEE 802.11 wireless LAN or Ethernet.

In the conventional PLC network constructed above, a control command for controlling the PLC devices 10, 20, and 30 is received through a webpage-based user interface (UI) in the Home PAD 40 and transmitted to the PLC server 100. When the control command sent through the PLC server 100 arrives at the PLC gateway 50, the PLC gateway 50 sends the control command to the PLC devices 10, 20, and 30 via the power line. The PLC gateway 50 gathers information on the PLC devices 10, 20, and 30 and sends the information to the PLC server 100 that manages the same information in database (DB). If there is a change in status of the PLC devices 10, 20, and 30, information regarding the change of status is transported through the PLC gateway 50 to the PLC server 100, which in turn sends the same information to the Home PAD 40 and other external devices connected thereto.

The conventional PLC technology has several problems. One problem associated with use of a webpage-based UI is that it is possible to achieve a user-to-device control, but not a device-to-device control. Another problem is that it is difficult to create an application for controlling a PLC device where other features are added. Another problem with use of the webpage-based UI is that it requires the appropriate webpage address to be found and set, and it also allows only external devices with a web browser to control a PLC device.

To address these problems, there is a need for implementation of a system, which allows a device-to-device control similar to a situation wherein a control point in the UPnP controls a controlled device while still using the conventional PLC technology.

### SUMMARY OF THE INVENTION

The present invention provides an apparatus and method for effectively realizing a Power Line Control (PLC)-to-Universal Plug And Play (UPnP) bridge in such a manner that PLC devices can join a UPnP network while meeting a standard device specification defined by the UPnP.

The invention also provides a method for generating and managing a bridge process suitable for PLC devices by retrieving necessary items from databases (DB) organized for the PLC devices, a method for organizing information on UPnP devices using information about the PLC devices, and a method for converting the status change of the PLC devices into events on the UPnP devices.

According to an aspect of the present invention, there is provided a bridging apparatus for enabling a Universal Plug And Play (UPnP) device to control Power Line Control (PLC) devices. The present invention also includes a unit for generating a device description XML document for each designated device type using information corresponding to the PLC devices and transmitting the XML document to a UPnP control point. Furthermore, it is an aspect of the present invention to provide a unit means for, upon receipt of a control command from a control point, converting the control command into a control command conforming to a PLC protocol, and transmitting the converted control command to a PLC device, and for, upon receipt of an information packet conforming to the PLC protocol from the PLC device, converting the packet to an event message conforming to a UPnP protocol, and transmitting the event message to the control point.

According to another aspect of the present invention, there is provided a bridging method for enabling a Universal Plug And Play (UPnP) device to control Power Line Control (PLC) devices including: retrieving information on PLC devices from a PLC server and storing the same; generating a UPnP device description using the information on a PLC device so that the PLC device can join a UPnP network; converting a control command received from a control point on the UPnP network to a control command conforming to a PLC protocol; and transmitting the converted control command to the PLC device.

### BRIEF DESCRIPTION OF THE DRAWINGS

The above features, as well as other features and advantages of the present invention, will become more apparent through a detailed description of the exemplary embodiments thereof, with reference to the attached drawings in which:

FIG. 1 shows the operation of a conventional Power Line Control (PLC) network;

FIG. 2 shows the overall structure of a bridging apparatus according to the present invention;

FIG. 3 is a block diagram showing the configuration of a PLC server according to the invention;

FIG. 4 is a block diagram showing the configuration of an UPnP-PLC bridge according to the invention;

FIG. SA shows the format of a packet carrying data sent or received between a UPnP-PLC bridge and a PLC server according to the invention, FIG. 5B shows values that can be recorded in a Command field and brief description thereof, and FIG. 5C shows the format of subfields in a Data field;

FIG. 6 is a flowchart briefly showing the overall operation of the bridging apparatus according to the invention; and

FIGS. 7-9 illustrate steps S20, S40, and S50 shown in FIG. 6, respectively.

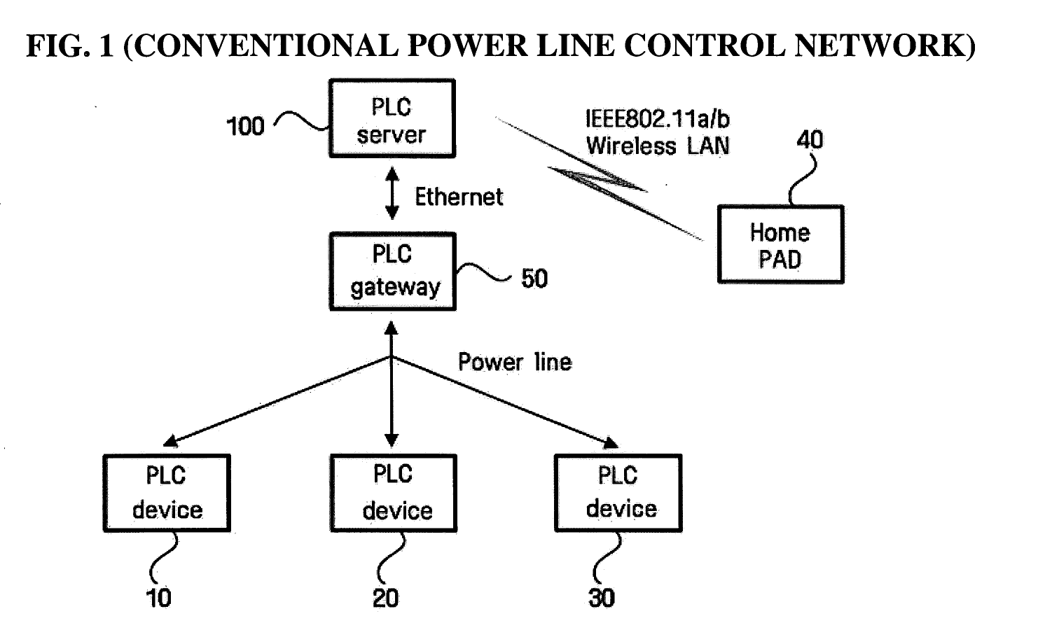

### DETAILED DESCRIPTION OF THE INVENTION

The present invention is intended to treat and control a Power Line Control (PLC) device on a conventional PLC network as if it were a Universal Plug And Play (UPnP) by integrating UPnP technology using ‘UPnP Device Architecture, Jun. 13, 2000, Version 1.0’ with a conventional PLC technology.

The invention will now be described more fully with reference to the accompanying drawings, in which exemplary embodiments of the invention are shown. This invention may, however, be embodied in many different forms and should not be construed as being limited to the embodiments set forth herein; rather, these embodiments are provided so that this disclosure will be thorough and complete, and will fully convey the concept of the invention to those skilled in the art. The spirit and scope of the invention is defined by the appended claims. In the drawings, the same reference numerals denote the same element.

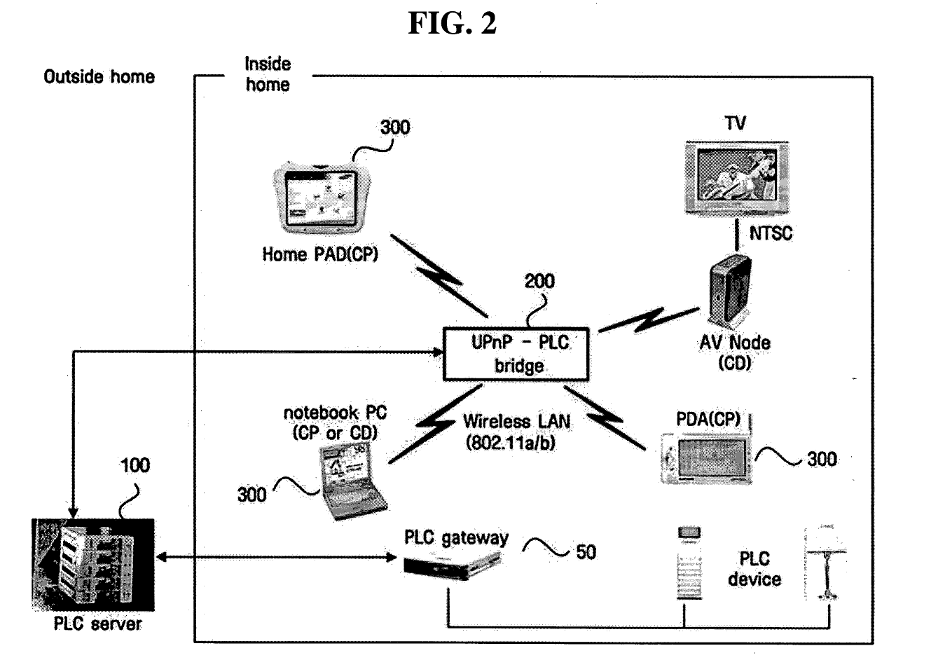

FIG. 2 shows the overall structure of a bridging apparatus according to the present invention. As shown in FIG. 2, one or more control points (CPs) and one or more controlled devices (CDs) controlled thereby are connected to an UPnP-PLC bridge 200 on a wired or wireless basis according to an UPnP protocol inside the home. Similarly, CDs connect with CPs on a wired or wireless basis.

A Home PAD 300, a TV, an AV node, a notebook PC 300, a PDA 300, and other Home devices inside the Home may operate as either CPs or CDs or both, depending on their functions. For example, while the Home Pad 300 and PDA 300 may act as a CP, the AV node may act as a CD. On the other hand, a notebook PC may serve as both a CP and a CD.

A PLC server 100 used outside the home controls PLC devices such as an air conditioner and an electric lamp via a PLC gateway 50. A control point 300 and the PLC server 100 connect with each other through the UPnP-PLC bridge 200 proposed by this invention, which allows the control point 300 to control the PLC devices while enabling the PLC devices to notify the control point 300 of changes in their states by sending event messages. To this end, a control command sent by the control point 300 must be converted into a command that a PLC network can recognize, while status change information transmitted by the PLC server 100 must be converted into information data that an UPnP network can recognize.

The UPnP-PLC bridge 200 according to an exemplary embodiment of the present invention must meet the following requirements: First, installation of UPnP CD Stack as well as communication with the PLC server 100 must be allowed. Second, the UPnP bridge 200 must support Multi-Tasking OS capable of creating a thread and process. Third, the UPnP-PLC bridge 200 must also be equipped with a Network Adapter capable of creating the UPnP network. Fourth, although the UPnP-PLC bridge 200 does not necessitate the use of input and output devices, it requires an auxiliary memory device for storing an XML document. For the auxiliary memory device, any device that can install and operate all of the above software can be used regardless of whether it is a multifunctional device.

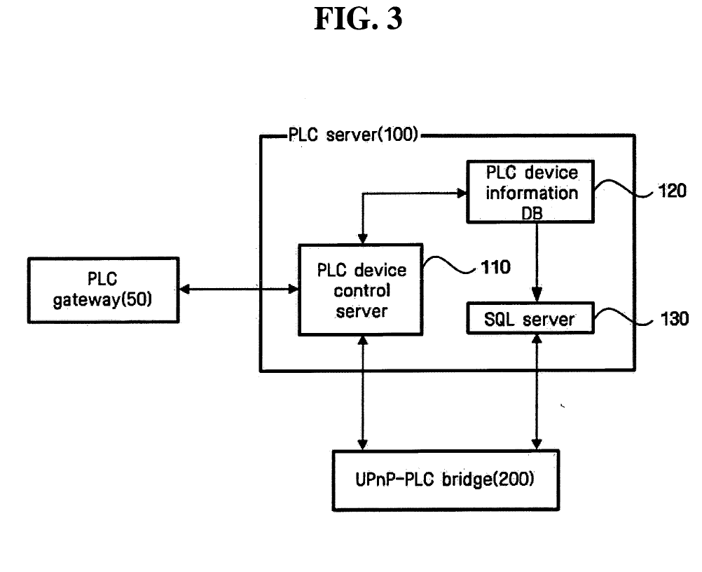

FIG. 3 is a block diagram showing the configuration of the PLC server 100 according to an exemplary embodiment of the invention.

The PLC server 100 of the embodiment of the invention may be configured conventionally. The PLC server 100 may be comprised of a PLC device control server 110, a PLC device information DB 120, and a SQL server 130. Connections between the PLC gateway 50 and the PLC device control server 110, between the PLC device control server 110 and the UPnP-PLC bridge 200, and between the SQL server 130 and the UPnP-PLC bridge 200 may be made via a wired or wireless communication medium capable of creating a network, such as Ethernet, IEEE 802.11a/b wireless LAN, and others.

The PLC device control server 110 receives a packet of a control command compliant with a PLC protocol from the UPnP-PLC bridge 200, and then sends the control command to the PLC gateway 50.

In addition, the PLC device control server 110 gathers information on PLC devices from the PLC gateway 50 and stores the gathered information in the PLC device information DB 120. The PLC device information DB 120 that has stored the gathered information on the PLC devices provides information regarding a particular PLC device to the SQL server 130 upon request by the SQL server 130.

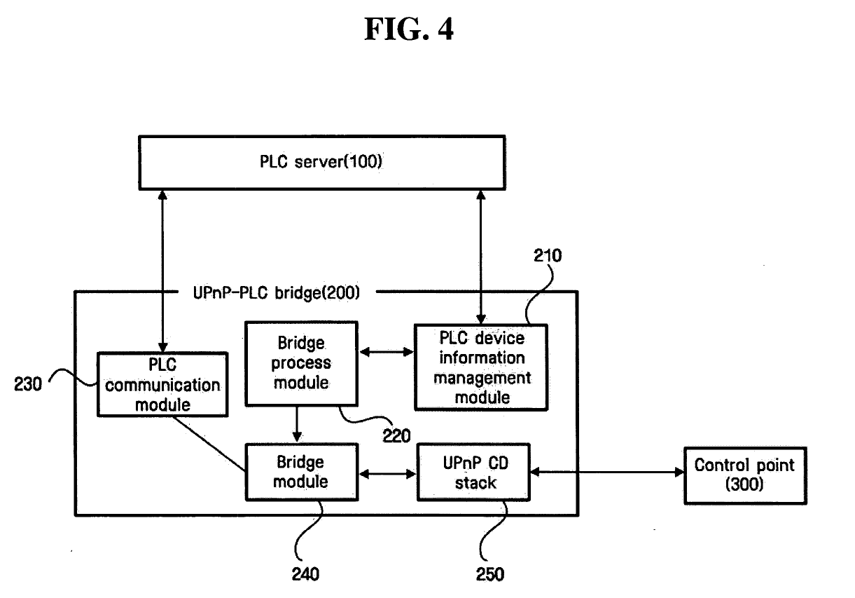

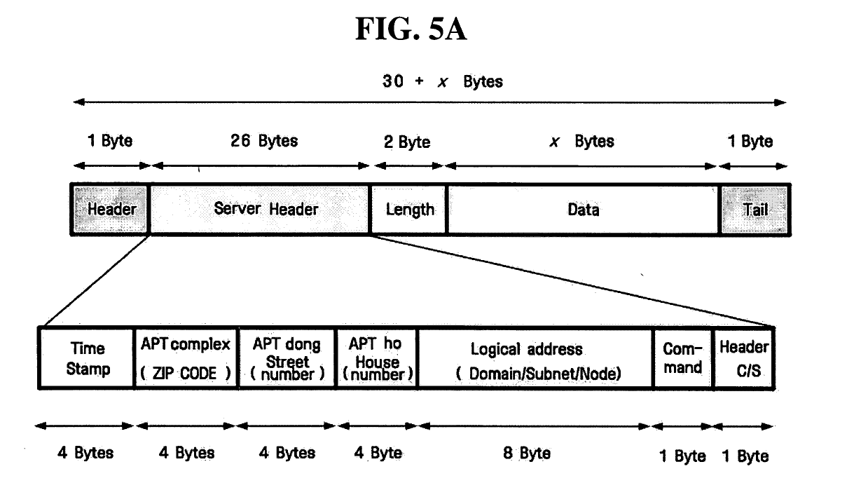

Upon receipt of a SQL query for information about the appropriate PLC device from a PLC device information management module (210 of FIG. 4) of the UPnP-PLC bridge 200, the SQL server 130 retrieves the information corresponding to the PLC device from the PLC device information DB 120 and transports the information to the PLC device information management module 210.

FIG. 4 is a block diagram showing the configuration of the UPnP-PLC bridge 200 according to the invention.

The UPnP-PLC bridge 200 may consist of a PLC communication module 230, a bridge process module 220, the PLC device information management module 210, a bridge module 240, and a UPnP CD Stack 250. A connection between the UPnP CD Stack 250 and the control point may be established through a wired or wireless communication medium capable of creating a network, such as Ethernet, IEEE 802.11a/b wireless LAN, and others.

The PLC communication module 230 waits to receive data from the PLC device control server 110 within the PLC server 100 and transports a control command received through the UPnP CD stack 250 which is converted to conform to a PLC protocol through the bridge module 240 to the PLC device control server 110.

The bridge process module 220 generates the bridge module 240 by the type of PLC devices using information on PLC devices stored in or managed by the PLC device information management module 210.

The PLC device information management module 210 accesses a SQL server 130 to request information about the appropriate PLC device from the SQL server 130 using a SQL query and obtains the applicable information therefrom.

The bridge process module 220 creates the bridge module 240 for each PLC device type, which generates a device description XML template for each device type using the information on PLC devices transmitted from the bridge process module 220, and dynamically modifies ‘Friendly Name’ and ‘Unique Device Name’, and creates an appropriate device description XML document using the XML template. If a control command is received from the control point 300 through the UPnP CD Stack 250, the bridge module 240 converts the control command to a command conforming to the PLC protocol and transports the converted command to the PLC communication module 230. Upon receipt of an information packet conforming to the PLC protocol from the PLC communication module 230, the bridge module 240 converts the packet into an event message conforming to the UPnP protocol and transports the event message to the control point 300 through the UPnP CD Stack 250.

FIG. 5A shows the format of a packet carrying data sent or received between the UPnP-PLC bridge 200 and the PLC server 100 according to the invention. The packet may be comprised of a 1-byte Header field, a 26-byte Server Header field, a 2-byte Length field, a variable-length Data field, and a 1-byte Tail field. The Server Header field may be divided into the following subfields. That is, a Time Stamp subfield specifies the time in milliseconds which have elapsed since the time at which packet transmission occurred, for example, Jan. 1, 1970. An APT Complex subfield indicates a unique ID number of an APT complex (zip code in the case of a detached house). An APT unit number (dong) subfield expresses an APT unit number in an ASCII value (street number in the case of a detached house). An APT number (ho) subfield indicates an APT floor/room number in ASCII value (house number in the case of a detached house). An Address subfield contains a unique logical address of PLC devices on a LonWorks network consisting of Domain/Subnet/Node ID, and a Command subfield indicates the type of commands transmitted to the PLC devices by the PLC server 100.

Different values are recorded in the Command subfield depending on the type of commands. FIG. 5B shows values that can be recorded in the Command subfield and brief description thereof, and FIG. 5C shows the format of subfields in the Data field.

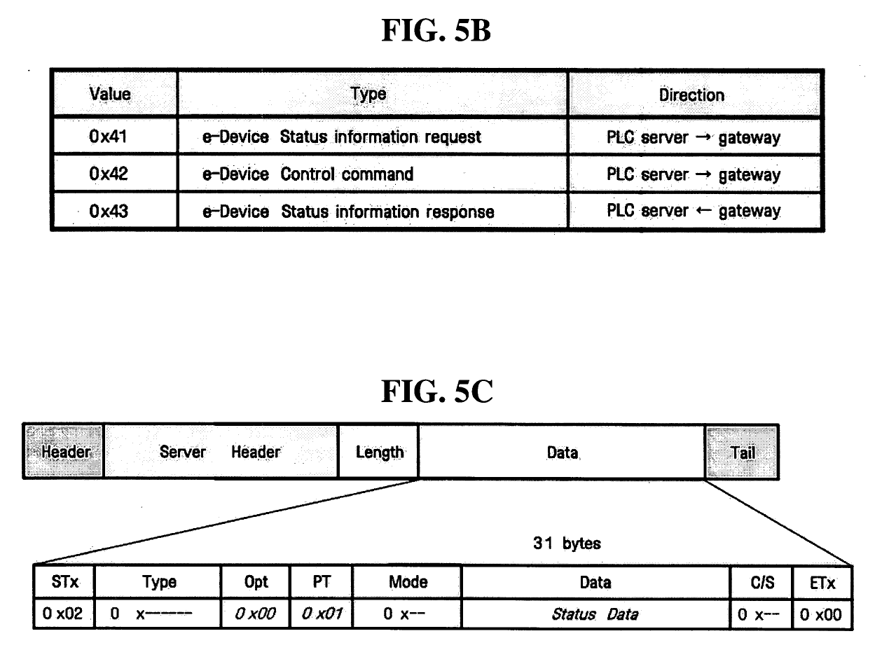

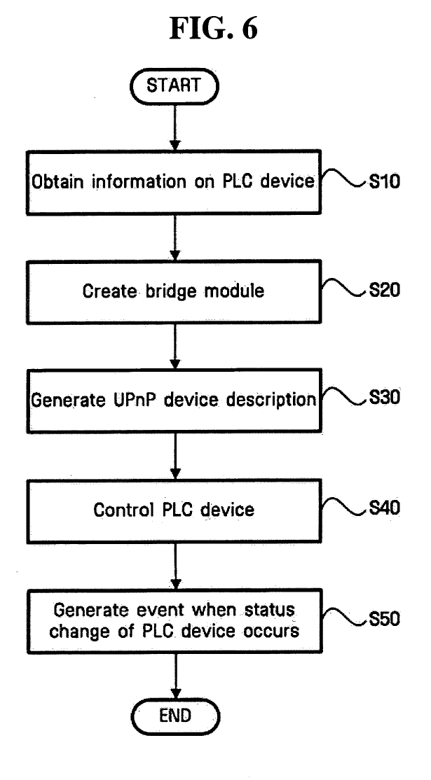

FIG. 6 is a flowchart briefly showing the overall operation of the bridging apparatus according to the invention configured as shown in FIGS. 4 and 5.

First, in step S10, the PLC device information management module 210 retrieves information corresponding to the PLC devices from the PLC information DB 120 through the SQL server 130 and stores the information.

In step S20, the bridge process module 220 creates the bridge module 240 for each device type using the information corresponding to the PLC devices.

Then, in step S30, the bridge module 240 generates a UPnP device description for each PLC device, so that a PLC device can join a UPnP network.

In step S40, when the control point 300 on the UPnP network sends a control command to a PLC device through the UPnP-PLC bridge 200 and the PLC server 100 in order to control the PLC device, the PLC device performs operation according to the command.

In step S50, if a status change occurs to a PLC device in response to the control command or due to other factors, the UPnP-PLC bridge 200 generates an event message that is then transmitted to the control point 300.

Specifically, in step S10 shown in FIG. 6, first, the bridge process module 220 calls the PLC device information management module 210. Then, the PLC device information management module 210 accesses the SQL server 130 to retrieve information corresponding to each PLC device, as shown in Table 1 below, from the PLC device information DB 120 using a SQL query.

TABLE 1

| Item | Description |
|---|---|
| Logical address | Address of PLC device on PLC network |
| | corresponding to Internet IP. |
| Neuron ID | Unique ED for each PLC device |
| Type of PLC device | Code to identify the type of PLC device |
| Nos. of PLC device | Number of PLC devices available on a |
| | PLC network |

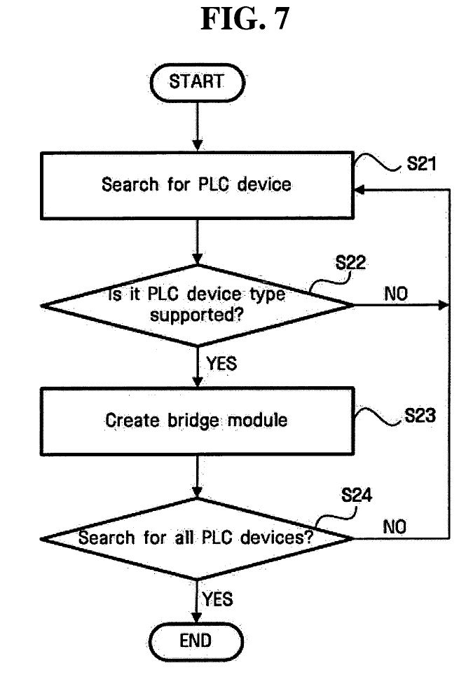

Step S20 of FIG. 6 will now be described in detail with reference to FIG. 7. The bridge process module 220 searches for Information corresponding to all PLC devices. The number of searches performed corresponds to the number of PLC devices discovered in Table 1 in step S21, and determines whether each PLC device belongs to a type that can be controlled by a UPnP control point in step S22. A developer or user may specify whether each PLC device belongs to a type that can be controlled.

Next, in step S23, the bridge process module 220 creates the bridge module 240 according to the type of each PLC device. For example, if the PLC device to be controlled on the UPnP network is designated as an electric lamp, a blind, or an air conditioner, the bridge module 240 is not generated for PLC devices other than electric lamps, blinds or air conditioners, even if information about other PLC devices has been searched for. The bridge process module 220 transmits parameters including information on how many bridge modules 240 have been created before the PLC device among PLC devices of the same type, network port to be used, logical address, and Neuron ID to the corresponding bridge module 240.

In step S24, it is checked whether searching has been conducted for all PLC devices or not. If not, the routine goes back to step S21, and if yes, the routine comes to an end.

If the PLC device specified in the information on the PLC devices belongs to an ‘electric lamp’ type, the step of creating the bridge module 240 (S20 as shown in FIG. 7) for the PLC device is implemented using pseudo codes as shown in Table 2 below. Similarly, where the PLC device to be controlled is designated as a ‘blind’ or ‘air conditioner’, the same process is repeated to confirm whether PLC devices belong to a blind or air conditioner type before creating the bridge module 240 for each device.

TABLE 2

/* Repeat Loop a number of times corresponding to the number
of PLC

devices installed */

for(i = 0; i < dev_nums; i++) {

/* Determine whether LC Device(0x220000) belongs to
electric

lamp type */

if (!strcmp(dev_class[i], “22”) && !strcmp(dev_type[i],
“00”)

&&

!strcmp(dev_sub_type[i], “0”) &&
!strcmp(rev_no[i],

“0”)) {

cd_pid[i] = fork( );
if (cd_pid[i] == −1) {

perror(“fork failed”);
return(−1);

}
else if (cd_pid[i] == 0) {

/* Allocate information on the number of bridge agents
actually

created for an electric lamp as well as a port number to be used. */

sprintf(cd_stridx, “%02d”, blight_idx);
sprintf(cd_strport, “%d”, BASE_CD_PORT
+ i);
/* Electric Lamp Bridge Agent Process
Creation

*/

execl(BLIGHT_PATH, BLIGHT_PROGNAME,

cd_stridx, cd_strport, servIP, apt_addr, dong_addr, ho_addr,
lo_addr[i], neuron_id[i], 0);

return(−1);

}

/* Increase the number of created PLC Device Bridge Agents
belonging to

an electric lamp type. */

blight_idx++;

}

}

Specifically, in step S30 shown in FIG. 6, the bridge module 240 uses a network port transmitted as one of the parameters in order to gain access to a description server on the UPnP network. Furthermore, when communicating with the PLC device control server 110, the bridge module 240 uses the logical address to designate a PLC device.

The bridge module 240 creates a device description XML template for each device type and dynamically modifies ‘Friendly Name’ and ‘Unique Device Name (UDN)’ in order to generate a suitable device description XML document. ‘Friendly Name’ is created by attaching information corresponding to the number of bridge modules 240 generated for the same type of devices to the content of the template. ‘Unique Device Name’ is created by use of a unique Neuron IDs.

For example, for an electric lamp, Friendly Name may be created by a prefix Nexus_Light followed by information on how many bridge modules 240 have been actually generated for an electric lamp, i.e., blight_idx, as shown in Table 2. Similarly, a second electric lamp is expressed by ‘Nexus_Light2’. Unique Device Name is generated by adding a 6-byte Neuron ID of a PLD device to the prefix. For example, the Unique Device Name may be represented by ‘Nexus_{—}02B373EE0000’. Table 3 shows an example in which a UPnP device description is expressed as an XML document where a PLC device is an electric lamp type.

TABLE 3
<?xml version=“1.0”?>
<root xmlns=“urn:schemas-upnp-org:device-1-0”>
<specVersion>

<major>1</major>
<minor>0</minor>

```
  </specVersion>
  <device>
```

<deviceType>urn:schemas-upnp-org:device:BinaryLight:1</deviceType>

<friendlyName>Nexus_Light1</friendlyName>

<manufacturer>Samsung Electronics</manufacturer>
<manufacturerURL>http://www.sec.co.kr</manufacturerURL>
<modelDescription>Samsung Electronics Nexus Binary Light PLC-to-UPnP

bridge 1.0</modelDescription>

<modelName>Binary Light</modelName>
<modelNumber>1.0</modelNumber>

<UDN>uuid:Nexus_02B373EE0000</UDN>

<serviceList>
<service>

<serviceType>urn:schemas-upnp-org:service:SwitchPower:1</serviceType>
<serviceId>urn:upnp-org:serviceId:SwitchPower</serviceId>
<SCPDURL>/SwitchPower1.xml</SCPDURL>
<controlURL>/upnp/control/SwitchPower</controlURL>
<eventSubURL>/upnp/event/SwitchPower</eventSubURL>

</service>
</serviceList>

</device>
</root>

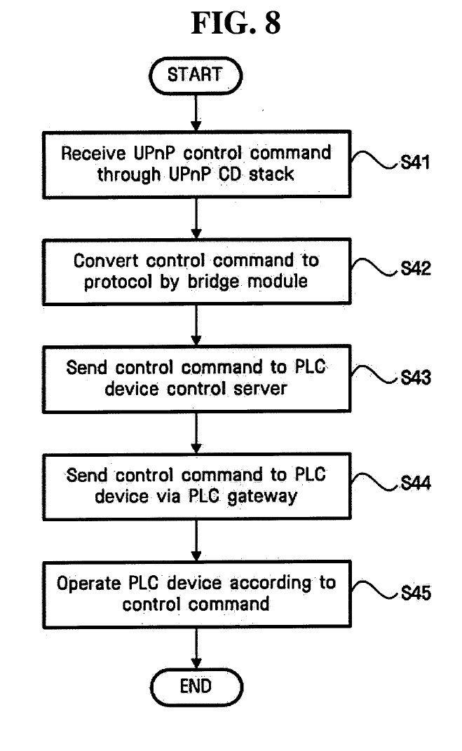

The step S40 in FIG. 6 will now be described in detail with reference to FIG. 8. First, the bridge module 240 activates the PLC communication module 230 and then runs the UPnP CD Stack 250. In step S41, if there is a control command on the UPnP network, the bridge module 240 receives the UPnP control command from the control point 300 through the UPnP CD Stack 250. In step S42, the bridge module 240 converts the control command to a protocol that can be used on the PLC network, which is then transported to the PLC device control server 110 via the PLC communication module 230 in step S43. When the PLC device control server 110 transmits the control command to a PLC device via the PLC gateway 50 in step S44, the appropriate PLC device operates as instructed by the control command in step S45.

Table 4 shows an XML document created by the control point 300 for requesting the ‘SwitchPower Service’ of the bridge module 240 so that the power to an electric lamp is turned on using a UPnP Simple Object Access Protocol (SOAP) message. The SOAP message contains argument ‘true’ of action ‘SetTarget’, as shown in Table 4 below. The XML document is created at the control point 300 and delivered to the appropriate bridge module 240 through the UPnP CD Stack 250.

TABLE 4

| <?xml version=“1.0” encoding=“utf-8”?> | |
|---|---|
| <s:Envelope | s:encodingStyle=“http://schemas.xmlsoap.org/soap/encoding/” |

xmlns:s=“http://schemas.xmlsoap.org/soap/envelope/”>
<s:Body>

<u:SetTarget xmlns:u=“urn:schemas-upnp-org:service:SwitchPower:1”>
<newTargetValue>true</newTargetValue>
</u:SetTarget>

</s:Body>
</s:Envelope>

Table 5 below shows an example in which a command issued from the control point 300, is converted from a UPnP protocol to a PLC protocol. The command converted to the PLC protocol instructs an electric lamp device to turn on power. In order to perform the conversion, the bridge module 200 for an electric lamp parses the UPnP SOAP message to call a function ‘SetTarget’, presented below, and then converts the control command conforming to the UPnP protocol to a control command conforming to the PLC protocol. The format of a packet of the converted control command, i.e., the control command conforming to the PLC protocol, is as shown in FIG. 5C. The difference is that the Command field of the packet is expressed by ‘0×42’.

TABLE 5

Int SetTarget(char *NewTargetValue)
{

char value[2];
int ret = 0;
/* Convert value of Action Argument parsed from UPnP
SOAP into a

unified value of 0 or 1 */

if ((strcmp(NewTargetValue, “0”) == 0) ∥

(strcmp(NewTargetValue, “false”) == 0) ∥
(strcmp(NewTargetValue, “no”) == 0))

{

strcpy(value, “0”);

}
else if ((strcmp(NewTargetValue, “1”) == 0) ∥

(strcmp(NewTargetValue, “true”) == 0) ∥
(strcmp(NewTargetValue, “yes”) == 0))

{

strcpy(value, “1”);

}
/* Notify that error occurs in Action Argument and return
a function. */
else
{

PRINT(“error: can't set power to value %s\n”,
NewTargetValue);
return(0);

}
/* Generate an actual PLC Device command and send it to
PLC Server. */
ret = Plc_BLightSetTarget(value);
if (ret)
{

return(0);

}
/* Update UPnP State Variable according to the result of
executing UPnP

Action. */

| | |
|---|---|
| ret | = |

DeviceSetServiceTableVar(SWITCHPOWER_TOKEN,

TARGET_TOKEN, value);

return(ret);

}
int
Plc_BLightSetTarget(char *NewTargetValue)
{

int i;
/* Generate Control Packet with important Argument to
respond to UPnP

Action request */

/* Here, tangoBuffer is a stream of 61 bytes for packet
sent to PLC server.

*/

| | |
|---|---|
| tangoBuffer[25] = 0x42; | /* Command */ |
| tangoBuffer[33] = 0x00; | /* Opt */ |
| tangoBuffer[34] = 0x01; | /* PT */ |
| tangoBuffer[35] = 0x00; | /* Mode */ |

if (strcmp(NewTargetValue, “1”))
{

| | |
|---|---|
| tangoBuffer[36] = 0x02; | /* DATA[0]: OFF */ |

}
else
{

| | |
|---|---|
| tangoBuffer[36] = 0x01; | /* DATA[0]: ON */ |

}
for(i = 37; i < 58; i++) {

tangoBuffer[i] = 0;

}
/* Send generated PLC Device Packet for an electric
lamp to PLC server. */
return (Plc_ComSendPacket(tangoBuffer));

}

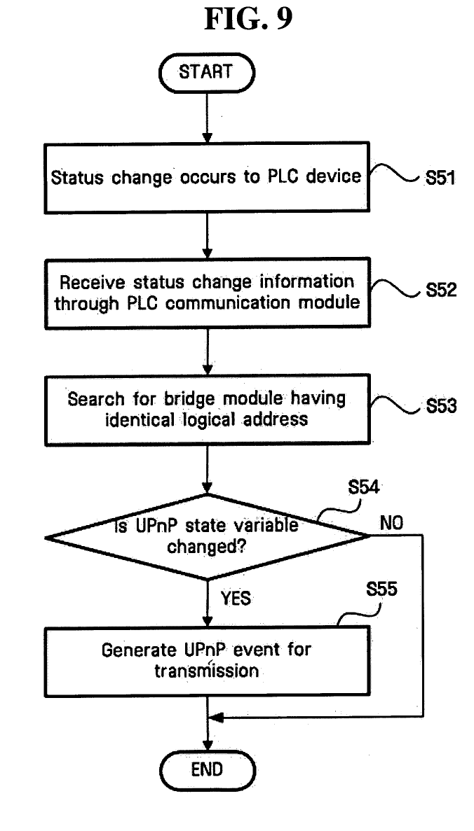

Step S50 in FIG. 6 will now be described with reference to FIG. 9. When a status change occurs to a specific PLC device in step S51, the PLC device control server 110 receives a status packet through the PLC communication module 230 and searches for the bridge module 240 corresponding to the status packet of the PLC device by inspecting whether both logical addresses coincide with each other in step S53. In this case, the value of a command field shown in FIG. 5B for the status packet is ‘0×43’. In step S54, the appropriate bridge module 240 checks if the content of the status packet has a change associated with a change in UPnP State Variable. If yes, a UPnP event is generated through an Application Program Interface (API) of the UPnP CD Stack 250 in step S55. If the inspection in step S54 does not reveal a change in the UPnP state variable, the routine shown in step S50, of FIG. 9, is terminated.

Table 6 shows an example in which the bridge module 240 converts a packet conforming to the PLC protocol to a packet conforming to the UPnP protocol when a UPnP event message is generated following a change in status of a PLC electric lamp:

TABLE 6

/* Create a thread so as to receive packet after a status change occurs to PLC
device. */
/* Initialize flag indicating thread termination condition. */

isPlcComFinish = 0;
/* Register function threadRecvStatus as sentence for creating thread,

and for an electric lamp, transmit address of Handler function that converts the
status change of electric lamp to UPnP Event as argument. */

res = pthread_create(&a_thread, NULL, threadRecvStatus, (void

*)Plc_EvHandler);

if (res != 0)
{

perror(“Thread creation failed”);
close(sock);
return (−1);

}

/* Thread for receiving status change packet from the PLC server */
static void *threadRecvStatus(void *arg)
{

int bytesRcvd, totalBytesRcvd; /* Bytes read in single recv( ) and total bytes

read */

Plc_EvFnPtr Plc_EvHandler;
uint8_t recvBuffer[PKT_SIZE]; /* Recv. buffer for tango packet */
Plc_EvHandler = (Plc_EvFnPtr)arg;
while (!isPlcComFinish)
{

/* Receive the packet from the server */
totalBytesRcvd = 0;
while(totalBytesRcvd < PKT_SIZE) {

/* Wait to receive status change packet from PLC server following status

change of PLC device. */

if ((bytesRcvd = recv(sock, recvBuffer, PKT_SIZE − totalBytesRcvd,

0)) <= 0)

{

perror(“recv( ) failed or connection closed prematurely”);
close(sock);
pthread_exit(0);

}

totalBytesRcvd += bytesRcvd; /* Keep tally of total bytes

*/

}

/* Call Handler function together with the content of packet received from the
PLC server in order to convert the status change packet to UPnP event. */

Plc_EvHandler(recvBuffer);

}
pthread_exit(0);

}
/* Use the following function to convert the status change packet for electric
lamp to UPnP event. */
void
Plc_BLightEventHandler(uint8_t *recvBuffer)
{

char value[MAX_VAR_LEN] = ““;
int i, ret = 0;
/* Check if the packet from the PLC server coincides with a current

status change for the electric lamp. To this end, check if both 8-byte logical
addresses coincide with each other. */

for(i = 0; i < 8; i++) { /* Domain/Subnet/Node ID */

if (recvBuffer[17 + i] != tangoBuffer[17 + i])

return;

}
/* Inspect status change of PLC electric lamp of interest and convert the

status to a UPnP state variable. */

if (recvBuffer[36] == 0x02)
{

strcpy(value, “false”); /* Off */

}
else
{

strcpy(value, “true”); /* On */

| } | |
|---|---|
| /* Update status change of electric lamp with UPnP state variable. */ | |
| ret | = DeviceSetServiceTableVar(SWITCHPOWER_TOKEN, |

STATUS_TOKEN, value);

/* When there has been a change in UPnP state variable, use UPnP

GENA to generate UPnP event and send the event to control points interested in
status change of electric lamp. */

if (ret == 1)

UPnP_CD_SendEvent(SWITCHPOWER_TOKEN,

SST[SWITCHPOWER_TOKEN].VariableName[STATUS_TOKEN],

value);

return;

}

The XML document, shown in Table 7 below, is used to demonstrate that an electric lamp switches from an OFF-state to an ON-state by sending a UPnP General Event Notification Architecture (GENA) event message. When the status of the electric lamp is changed, the UPnP event message operation is performed by notifying the applicable control point 300 of the content contained within the XML document. Within the XML document shown in Table 7, ‘Status’ represents the name of the UPnP state variable, and ‘true’ represents the value of the state variable.

TABLE 7

<?xml version=“1.0” encoding=“utf-8”?>
<e:propertyset xmlns:e=“urn:schemas-upnp-org:event-1-0”>
<e:property>

<Status>true</Status>

</e:property>
</e:propertyset>

Although only a few embodiments of the present invention have been shown and described with reference to the attached drawings, it will be understood by those skilled in the art that changes may be made to these elements without departing from the features and spirit of the invention. Therefore, it is to be understood that the above-described embodiments have been provided only in a descriptive sense and will not be construed as placing any limitation on the scope of the invention.

The invention is advantageous in achieving a device-to-device control for PLC devices operating on a conventional PLC network. By simply setting up the address of a PLC server in a PLC-to-UPnP bridge, the PLC devices are allowed to automatically join the UPnP network.

Also, according to the present invention, it is easier to develop a UPnP application in which the PLC devices are combined with different UPnP devices, since the PLC devices meet the UPnP device standard.

Further, according to the present invention, a device supporting a UPnP application is allowed to control PLC devices without the aid of a web browser.

1. A bridging apparatus for enabling at least one Universal Plug And Play (UPnP) device to control at least one Power Line Control (PLC) device, the bridging apparatus comprises:
means for generating a device description XML document for at least one designated PLC device type using information corresponding to the at least one PLC device, and transmitting the XML document to a control point;
means for receiving a control command from the control point, converting the control command into a control command conforming to a PLC protocol, and transmitting the converted control command to the at least one PLC device; and
means for receiving an information packet conforming to the PLC protocol from the at least one PLC device, converting the information packet to an event message conforming to a UPnP protocol and transmitting the event message to the control point.

2. The bridging apparatus of claim 1, further comprising,
means for receiving information corresponding to the at least one PLC device from a PLC server and storing the information.

3. The bridging apparatus of claim 1, wherein, to generate the device description XML document, a device description XML template is created for the at least one designated PLC device type.

4. The bridging apparatus of claim 3, wherein, the device description XML template contains a generated FriendlyName and a generated Unique Device Name (UDN), which represents the at least one PLC device.

5. The bridging apparatus of claim 4,
wherein the at least one PLC device is connected to a PLC gateway,
wherein the FriendlyName is generated by a combination of a predetermined prefix and a number corresponding to a number of PLC devices which were connected to the PLC gateway before the at least one PLC device was connected to the PLC gateway, and
wherein the at least one PLC device and the number of PLC devices that were connected to the PLC gateway before the at least one PLC device belong to the same designated PLC device type.

6. The bridging apparatus of claim 4, wherein the UDN is generated by a predetermined prefix followed by a Neuron ID specified in the information corresponding to the at least one PLC device.

7. A bridging method for enabling at least one Universal Plug And Play (UPnP) device to control at least one Power Line Control (PLC) device, the bridging method comprises:
retrieving information corresponding to the at least one PLC device from a PLC server and storing the information;
generating a UPnP device description using the information corresponding to the at least one PLC device for the at least one PLC device to join a UPnP network; and
converting a control command received from a control point on the UPnP network to a control command conforming to a PLC protocol, and transmitting the converted control command to the at least one PLC device.

8. The bridging method of claim 7, further comprising, when a status change occurs to the at least one PLC device, and a packet containing information corresponding to the status change is received, converting the packet to an event message conforming to a UPnP protocol and transmitting the event message to the control point.

9. The bridging method of claim 7, wherein in the generating the UPnP device description, a device description XML template is created for at least one designated PLC device type.

10. The bridging method of claim 7, wherein, the device description XML template contains a generated FriendlyName and a generated Unique Device Name (UDN), which represents the at least one PLC device.

11. The bridging method of claim 10,
wherein the at least one PLC device is connected to a PLC gateway,
wherein the FriendlyName is generated by a combination of a predetermined prefix and a number corresponding to a number of PLC devices which were connected to the PLC gateway before the at least one PLC device was connected to the PLC gateway, and
wherein the at least one PLC device and the number of PLC devices that were connected to the PLC gateway before the at least one PLC device belong to the same designated PLC device type.

12. The bridging method of claim 10, wherein the UDN is generated by a predetermined prefix followed by a Neuron ID specified in the information corresponding to the at least one PLC device.

13. A computer readable recording medium for recording a program for executing the bridging method of claim 7 in a computer readable program.

14. A bridging apparatus comprising:
at least one communication module to transmit/receive data to/from a control server;
at least one access module that accesses a different server to request information corresponding to at least one PLC device;
at least one process module that creates another module for the at least one PLC device; and
at least one stack that transports data between a control point and the control server.

15. The bridging apparatus according to claim 14,
wherein said another module generates a device description XML template for at least one designated PLC device type using information corresponding to the at least one PLC device.
